(19) United States
(12) Patent Application Publication
(10) Pub. No.: US 2016/0113218 A1
(43) Pub. Date: Apr. 28, 2016

(54) Drip Emitter Tubing Expandable Into Grid

(71) Applicant: Rain Bird Corporation, Azusa, CA (US)

(72) Inventors: Michael F. Turk, Porter Ranch, CA (US); Kevin Scott Judd, Irvine, CA (US)

(21) Appl. No.: 14/921,484

(22) Filed: Oct. 23, 2015

Related U.S. Application Data
(60) Provisional application No. 62/067,938, filed on Oct. 23, 2014.

(51) Int. Cl. A01G 25/02; B05B 1/20; B05B 1/02

(52) U.S. Cl. CPC A01G 25/02; B05B 1/02; B05B 1/20

(57) ABSTRACT

Expandable drip emitter tubing is provided that can be moved from a compact configuration to an expanded, grid-like configuration. The tubing includes primary tubes supplied with fluid, which in turn feed secondary tubes. The secondary tubes rotatably connect the primary tubes, and allow the primary tubes to move from the compact configuration to the expanded configuration while in the latter configuration maintaining spacing within desired limits. Advantageously, the secondary tubes can be configured to include emission points, thereby increasing the number of emission points and the density of such emission points.

### CROSS-REFERENCE To RELATED APPLICATIONS

This application claims benefit of U. S. Provisional Application No. 62/067,938, filed Oct. 23, 2014, which is hereby incorporated herein by reference in its entirety.

### FIELD

Drip emitter tubing is described herein and, in particular, drip emitter tubing that is expandable into a grid in order to provide increased coverage.

### BACKGROUND

Drip emitter tubing can be used for water-efficient irrigation. Such tubing includes spaced emitters along the length of the tubing. When placed for irrigation, such as subsurface, water can be discharged through the emitters. Drip emitter tubing can be arranged subsurface in parallel rows spaced about 12 inches apart. For some applications, such a spacing can be undesirable, resulting in too large a spacing for the emission points. However, it can be more labor intensive and less efficient to arrange the drip emitter tubing closer together.

### SUMMARY

Preassembled drip tubing is provided that has at least one primary tube and a plurality of discrete, predefined emission points in fluid communication with the primary tube. The drip tubing is movable from a coiled configuration to an expanded configuration, where the discrete emission points are farther from the primary tube as compared to in the coiled configuration, to form an array of the emission points.

Expandable drip emitter tubing is provided that can be moved from a compact configuration, such as in a coil, to an expanded, grid-like configuration. The tubing includes primary tubes supplied with fluid, which in turn feed secondary tubes. The secondary tubes rotatably connect the primary tubes, and allow the primary tubes to move from the compact configuration to the expanded configuration while in the latter configuration maintaining spacing within desired limits. Advantageously, the secondary tubes can be configured to include emission points, thereby increasing the number of emission points and the density of such emission points.

The expandable drip emitter tubing can include a pair of primary tubes. Drip distributors are spaced along the primary tubes. The drip distributors of one of the primary tubes each having a corresponding drip distributor of the other of the primary tubes, with corresponding drip distributors connected by secondary tubes. The drip distributors are rotatable relative to the primary tubes, such that the connected secondary tubes can be rotated from being closer to parallel to the primary tubes toward being more perpendicular to the primary tubes when the tubing is moved from the compact configuration to the expanded configuration. In the compact configuration, the primary tubes are closer together than in the expanded configuration. When in the expanded configuration, the primary and secondary tubes are in a generally ladder-shaped or grid-like orientation, forming an array of discrete emission points.

Optionally, the secondary tubes can include laterally extending segments, thereby further increasing the coverage and density of the emission points. The drip distributors can be configured for emitting fluid, both externally and to a segment of the secondary tubing connected to the corresponding drip distributor and to any lateral segments of the secondary tubing. Emission points can be disposed on the drip distributor itself, as well as on the secondary tubes.

The drip distributors can be configured for pressure reduction. The drip distributors can be configured for emitting fluid externally of the tubing. The secondary tubes can also be configured for emitting fluid externally of the tubing.

The secondary tubes can have segments extending on opposite sides of at least one, and preferably both, of the primary tubes, such that lateral segments extending outwardly of the primary tubing form middle segments between the primary tubes. The segments of the secondary tubes can be discrete, and can be configured so as to not be in fluid communication with each other.

In one configuration, the tubing can be configured with six emission points extending transverse to the pair of primary tubes. One emission point can be on one of the drip distributors and another on the other one of the drip distributors. Two emission points can be on the middle segment of the secondary tubing. One emission point can be on one of the lateral segments of the secondary tubing, and another on the other lateral segment of the secondary tubing. The secondary tubes can optionally be configured to block fluid flow between adjacent locations for emitting fluid disposed between the pair of primary tubes.

The drip distributors can include an inlet in fluid communication with an associated one of the primary tubes and three outlets, one of the outlets configured for emitting fluid externally of the tubing, one of the outlets configured for emitting fluid to one segment of the secondary tubes, and another of the outlets configured for emitting fluid to another one of the segments of the secondary tubes. The drip distributors can include a tortuous path extending between the inlet and the outlets to reduce pressure therebetween. The drip distributors can also include a flexible valve for regulating fluid flow in response to pressure changes at the inlet.

The tubing can be provided in the compact configuration in a coil. To install, the tubing can be unwound from the coil. The unwound tubing can be moved from the compact configuration into the expanded configuration, and then installed, such as for subsurface irrigation.

### BRIEF DESCRIPTION OF THE DRAWINGS

FIG. 1 is a perspective view of a segment of expandable drip emitter tubing expanded into a grid, and showing a pair of parallel primary tubes each with drip distributors and adjacent pairs of drip distributors connected by secondary tubing;

FIG. 2 is a perspective view of the drip emitter tubing of FIG. 1 but showing an unexpanded configuration of the drip emitter tubing;

FIG. 3 is a perspective view of the drip emitter tubing of FIG. 1 in both a coiled configuration and partially unwound and moved into the expanded configuration;

FIG. 4 is a perspective view of one of the drip distributors;

FIG. 5 is a cross-section view of the drip distributor of FIG. 4 taken along line 5-5 thereof;

FIG. 6 is a bottom perspective view of the drip distributor of FIG. 4 with the secondary tubing and a bottom housing removed;

FIG. 7 is a front perspective view of the drip distributor of FIG. 4 with the secondary tubing removed;

FIG. 8 is an exploded view of the drip distributor as shown in FIG. 7;

FIG. 9 is a bottom plan view of a segment of a first alternative drip emitter tubing arrangement;

FIG. 10 is a bottom plan view of a segment of a second alternative drip emitter tubing arrangement;

FIG. 11 is a perspective view of a segment of a third alternative drip emitter tubing arrangement, showing a secondary tubing outwardly from primary tubing by tertiary tubing;

FIG. 12 is a perspective view of the drip emitter tubing arrangement of FIG. 11, showing the tertiary tubing wrapped around the primary tubing;

FIG. 13 is a perspective view of the drip emitter tubing arrangement of FIG. 11, showing the tertiary tubing wrapped around the secondary tubing;

FIG. 14 is a perspective view of a segment of a fourth alternative drip emitter tubing arrangement;

FIG. 15 is an exploded perspective view of the drip emitter tubing arrangement of FIG. 14, showing a top sheet, a bottom sheet, a permeable fabric and a primary tube;

FIG. 16 is a perspective view of the drip emitter tubing arrangement of FIG. 14, but with the top sheet and permeable fabric omitted; and

FIG. 17 is a perspective view of a segment of a fifth alternative drip emitter tubing arrangement.

### DETAILED DESCRIPTION

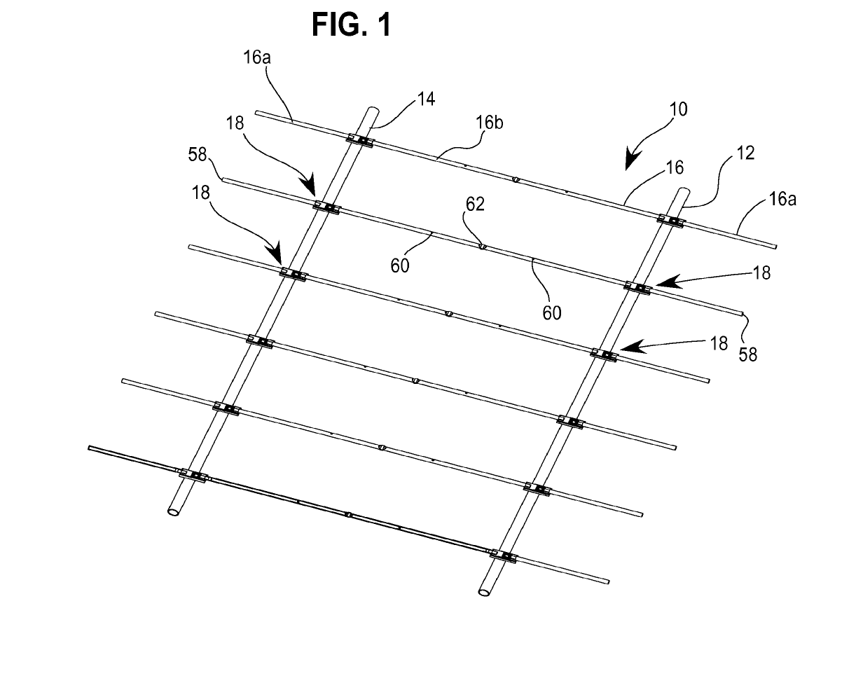

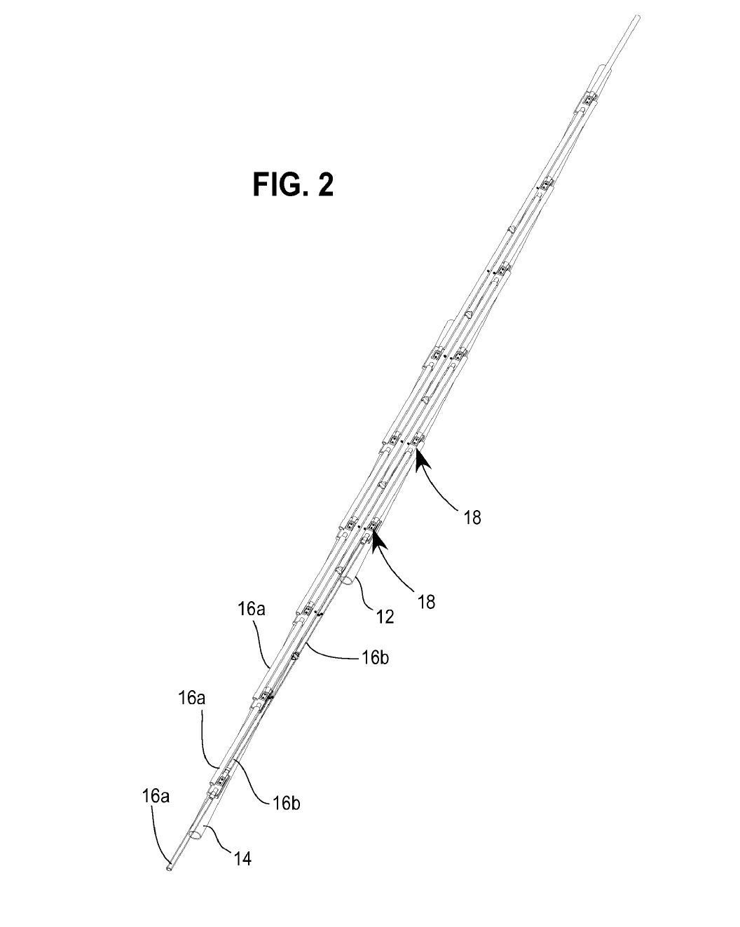

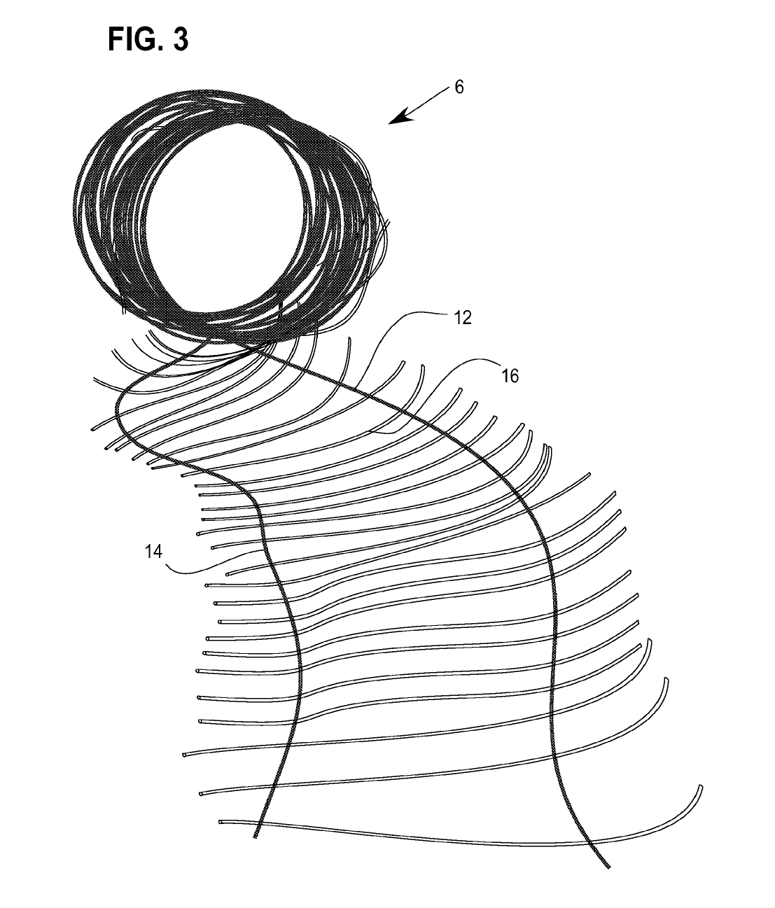

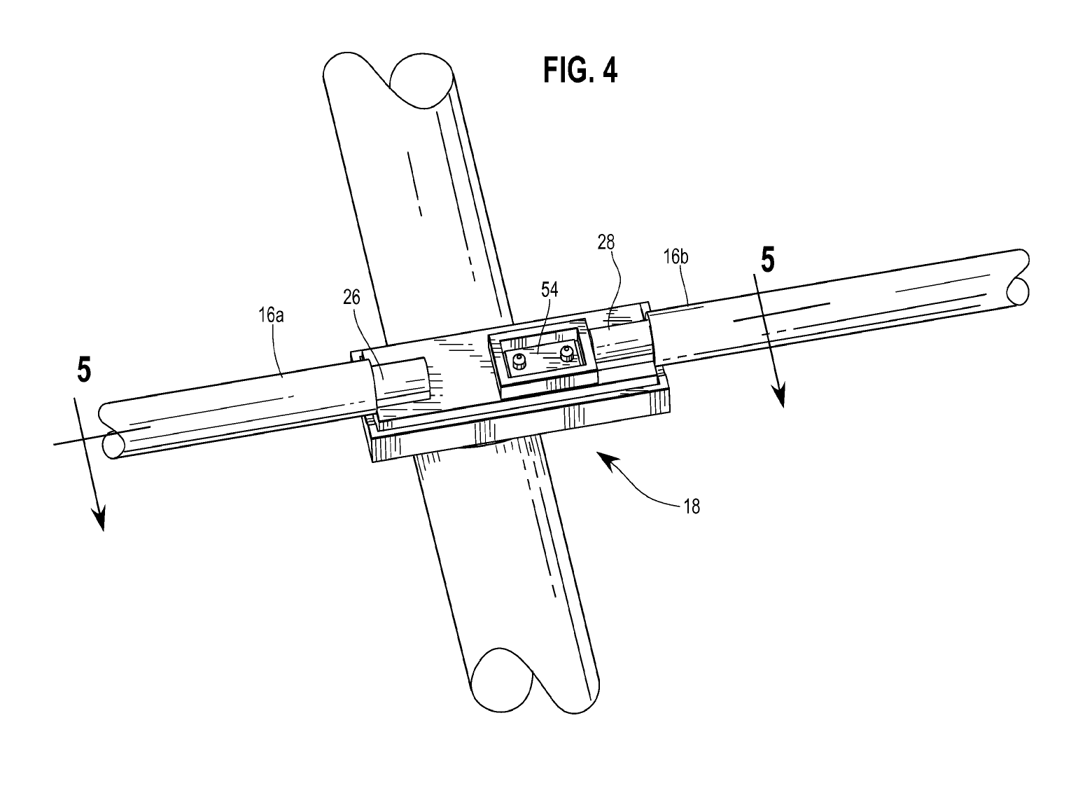

Expandable drip emitter tubing 10 is provided that can be moved from a coiled configuration, as shown in FIG. 3, or compact configuration, such as shown in FIG. 2, to an expanded, grid-like configuration, such as shown in FIG. 1. The tubing includes primary tubes 12 and 14 that can be supplied with fluid, which in turn feed secondary tubes 16. The secondary tubes 16 rotatably connect the primary tubes 12 and 14, and allow the primary tubes 12 and 14 to move from the compact configuration, such as shown in FIG. 2, and which can be provided on a coil, as shown in FIG. 3, to the fully expanded configuration, such as shown in FIG. 1. In the expanded configuration the secondary tubes 16 maintain spacing of the primary tubes 12 and 14 within desired limits, such that the grid-like configuration results. It will be appreciated that the grid-like configuration does not have to be where the primary tubes 12 and 14 are parallel and the secondary tubes 16 are perpendicular thereto; for some installations it may be desirable to have the primary tubes 12 and 14 closer together, in which case the secondary tubes 16 can be angled relative thereto, e.g., 45 degrees, 30/60 degrees, 15/75 degrees, etc.

Advantageously, not only are discrete emission points spaced at predetermined locations along each of the primary tubes 12 and 14, but the secondary tubes 16 also includes discrete emission points spaced at predetermined locations, thereby increasing the number of emission points and the density of such emission points as compared to typical drip line. The tubing 10 can advantageously be provided preassembled, thereby reducing labor required for installation. Further, the compact configuration, shown in FIG. 2, can be provide in a coiled configuration, as shown in FIG. 3, for ease of transport and usage.

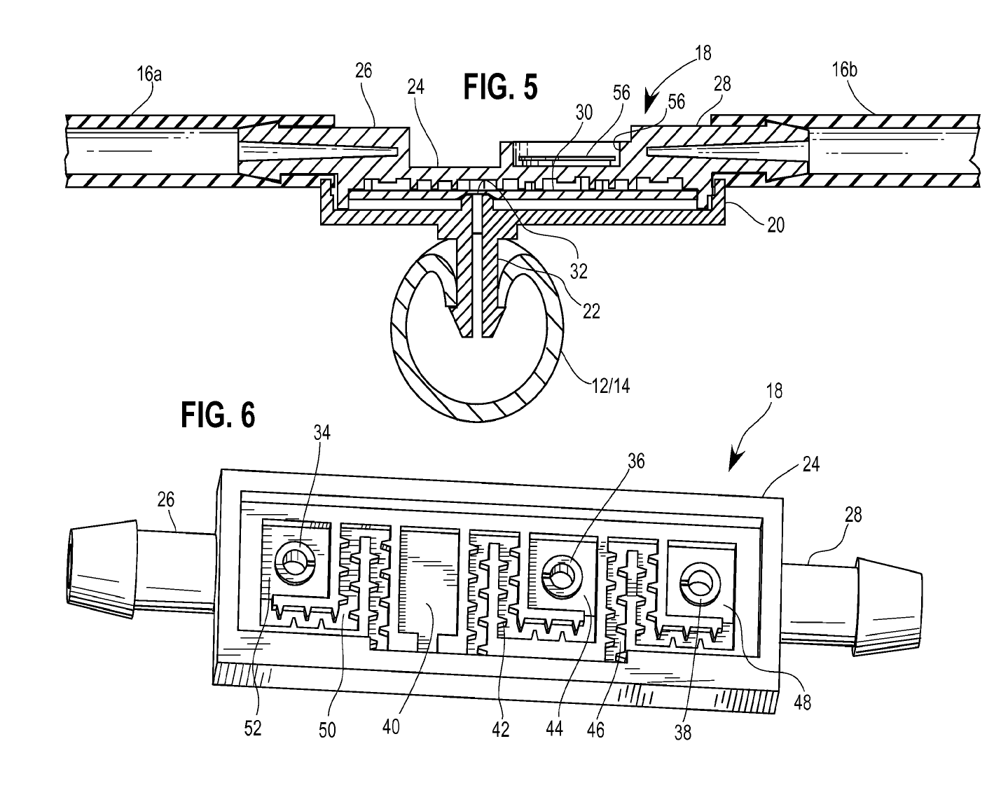

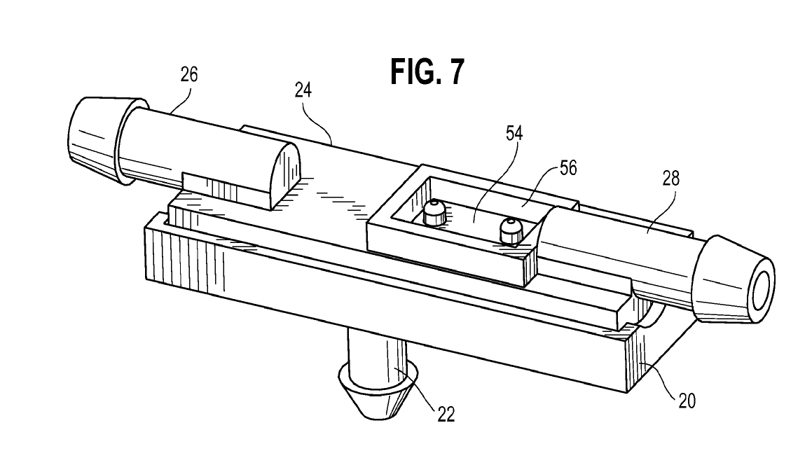

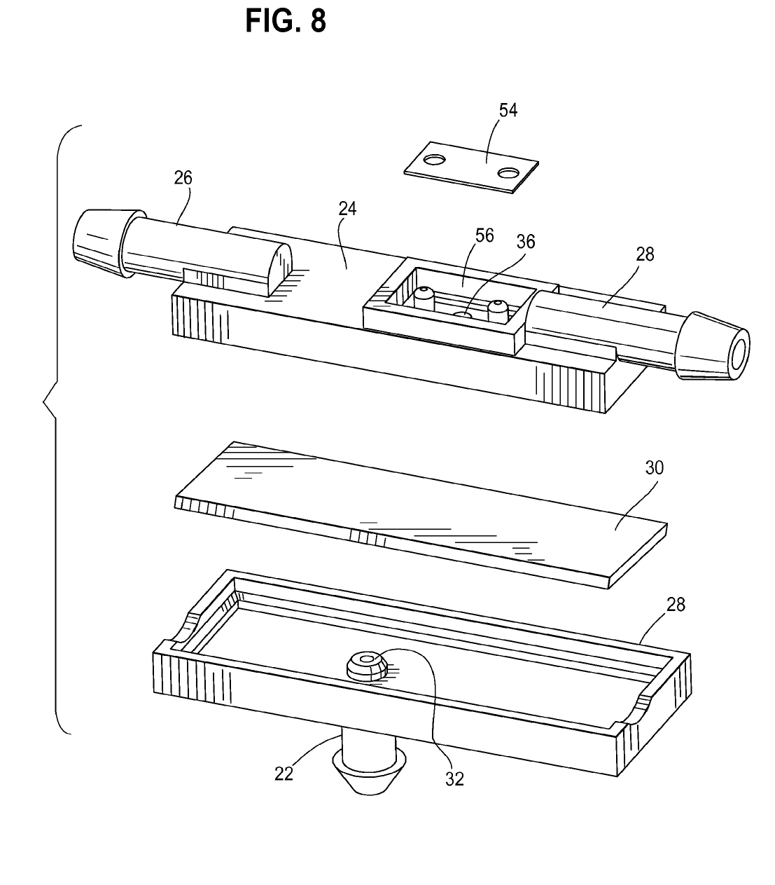

Drip distributors 18 are used to rotatably connect the primary tubes 12 and 14 with the secondary tubes 16. In particular, the drip distributors 18 can have a barbed fluid port 22, as shown in FIG. 5. The barbed fluid port 22 can be configured to be inserted into an opening, whether formed by the barbed fluid port 22 itself or in another manner, of the primary fluid tubes 12 or 14. Each of the fluid distributors 18 has a lower housing 20 and an upper housing 24 joined together to define an interior therebetween, for purposes of which will be described in greater detail herein. The upper housing 24 includes an opposing pair of barbed connection ports 26 and 28 that are adapted to be connected to the secondary tubes 16 and, in particular, to a lateral secondary tube 16a and a middle secondary tube 16b, as will be described further herein.

The drip distributors 18 can rotate relative to the primary tubes 12 and 14 by rotation of the barbed fluid port 22 within the opening of the primary tubes 12 or 14. The connected secondary tubes 16 can be rotated from being closer to parallel to the primary tubes 12 and 14, as shown in FIG. 2, toward being more perpendicular to the primary tubes 12 and 14, as shown in FIG. 1. In the compact configuration, shown in FIG. 2, the primary tubes 12 and 14 are closer together than in the expanded configuration, shown in FIG. 1.

As mentioned above, the secondary tubes 16 include lateral secondary tubes 16a and middle secondary tubes 16b. The lateral secondary tubes 16a extend outwardly past the primary tubes 12 and 14, as shown in FIG. 1, and terminate at a free end 58, with the other end being connected to one of the connection ports 26 of the upper housing 24 of the drip distributor 18. The middle secondary tubes 16b each extend between the other of the connection ports 28 of the upper housing 24 of the drip distributor 18, thereby connecting the primary tubes 12 and 14, as shown in FIGS. 1 and 2.

Multiple, discrete emission points are provided along the length of each of the primary tubes 12 and 14 at predetermined locations, to form an array of emission points. More specifically, each of the drip distributors 18 function as an emission point, as well as to supply fluid to the secondary tubing 16. The secondary tubing 16 also includes discrete emission points at predetermined locations. By being predetermined, the location of the emission point on the primary or secondary tubes is predetermined, as opposed to uncontrolled emission along their length. More specifically, the free end 58 of the lateral secondary tubes 16a can simply be open to function as an emission point, allowing fluid to exit. Each of the middle secondary tubes 16b includes a pair of openings 60 which function as emission points. Accordingly, transverse to the expanded tubing 10, as shown in FIG. 1, there are six emission points: one at the free end 58 of each of the two lateral secondary tubes 16a, one at each of the corresponding drip distributors 18, and two of the middle secondary tubes 16b. The middle secondary tubes 16b also include a crimped portion 62 which blocks fluid flow therepast. Thus, each of the drip distributors 18 supplies three emission points.

In an exemplary embodiment, each of the drip distributors 18 are spaced a distance x along the primary tubes, the lateral secondary tubes 16a have a length of x such that the free end 58 thereof is spaced a distance x from the adjacent one of the primary tubes 12 or 14 when the lateral secondary tubes 16a are at right angles thereto, and the middle secondary tubes 16b have a length of 3x such that, when they are at right angles to both of the primary tubes 12 and 14, each of the pair of openings 60 of the middle secondary tubes 16b are spaced a distance x from the adjacent one of the primary tubes 12 and 14. This will result in an array having six emission points extending approximately in a line transverse to the primary tubes 12 and 14 when the tubing 10 is in the expanded configuration. The variable x can be any suitable number. For example, if the variable x is six inches, then the primary tubes 12 and 14 will be spaced eighteen inches apart when expanded. It will be understood that in the installation environment the expanded configuration will often not result in tubes 12, 14, and 16 that are in precise parallel or perpendicular orientations, and that the variable x includes a margin of deviation. Although distances and ratios are used in this exemplary embodiment, it will be appreciated that there are many different array patterns possible by varying spacing between emission points, the number of tubes, and the number of emission points.

The emitter in the above embodiment is commonly referred to as a ‘point source’ emitter since it is plugged into a primary tube at a given point. Emitters that are embedded inside drip tubing are commonly referred to as in-line emitters. One skilled in the art could integrate in-line drip emitters into the primary tube, and/or the secondary tubes to modify the array as seen fit. This might be done for cost reasons or to achieve a specialized array for a given crop type or landscape design. An extreme of this alternative would be to not even use a point source emitter, instead using blank fittings common in the industry, with the same rotation features as the primary embodiment to transfer water, leaving all the discrete emission points to be of the in-line type.

When the variable x is six inches, then nine emission points are present in a square foot. Compared to typical grip tubing spaced twelve inches apart, and with the emission points of adjacent rows of tubing aligned (as is not often the case), and with emission points spaced twelve inches apart on the tubing, only four emission points are present in a square foot. A smaller density of emission points can require more water per point, but such water must travel farther to reach intermediate portions of the area to be irrigated. The higher density of emission points, as in the tubing 10 described herein, means that each point needs to emit less water, and that the water does not have as far to travel to reach intermediate portions of the area to be irrigated. This can result in more efficient irrigation, as the amount of water required to travel far is minimized.

Turning now to details of the drip distributor 18, the distributor 18 is configured to reduce the pressure of water received from the primary tube 12 or 14 and distribute that water both directly to the area to be irrigated, i.e., functioning as an emission point, and to the secondary tubes 16. Disposed within the interior defined between the upper and lower housings 20 and 24 is a flexible, pressure compensating elastomer element 30 generally planar in configuration. An upstream side of the elastomer element 30, disposed between the elastomer element 30 and the bottom housing 20, is an inlet opening 32 in fluid communication with the interior of the primary tube 12 or 14 via the barbed fluid port 22. The elastomer element 30 is held compressed over the inlet 32 such that a minimum amount of pressure is required to lift the elastomer element 30 to allow water to enter the rest of the emitter 18. Conversely, if water pressure to a system is turned off, this contact between the elastomer element 30 and the inlet 32 prevents water from flowing back through the inlet, which could otherwise happen on installation sites where there are elevation changes. This feature is commonly referred to as a check valve or anti-siphon feature.

Water can flow around the end of the elastomer element 30 to the downstream side thereof, between the element 30 and the upper housing 24. The upper housing 24, as shown in FIG. 6, includes a variety of features for reducing the pressure of the water and distributing the water. The water can flow into four paths. Moving left to right in FIG. 6, one of the paths 50 is a tortuous path that feeds a lateral secondary tube 16 through chamber 52 having an outlet 34 in fluid communication with the connection port 26 to which the lateral secondary tube 16 is attached. There is also a chamber 40 that is disposed on an opposite side of the elastomer element 30 from the inlet 32 that provides clearance for the check valve feature. This chamber 40 is for dimensional clearance reasons and communicates with the water path so water can freely move in and out of the chamber 40 when the check valve is opening and closing. Next, another tortuous path 42 feeds a direct emission chamber 44 that has an outlet 36. Finally, on the right side of FIG. 6, another tortuous path 46 feeds another chamber 48 having an outlet 38 in fluid communication with the connection portion 28 and the middle secondary tube 16b connected thereto. On an exterior of the upper housing is an optional recess 56 into which the outlet 36 of the direct emission chamber 44 feeds. Disposed within the recess 56 can be a copper plate 54, as shown in FIG. 5, for purposes of hindering root growth into the outlet 36. The upper and lower housings 20 and 22 can be joined together by ultrasonic welding or other suitable ways. The outlets 34, 36 and 38 can be configured for pressure compensation, in the form of small grooves into and out of which the elastomeric element can flex to decrease or increase the flow area through the groove in response to upstream pressure changes.

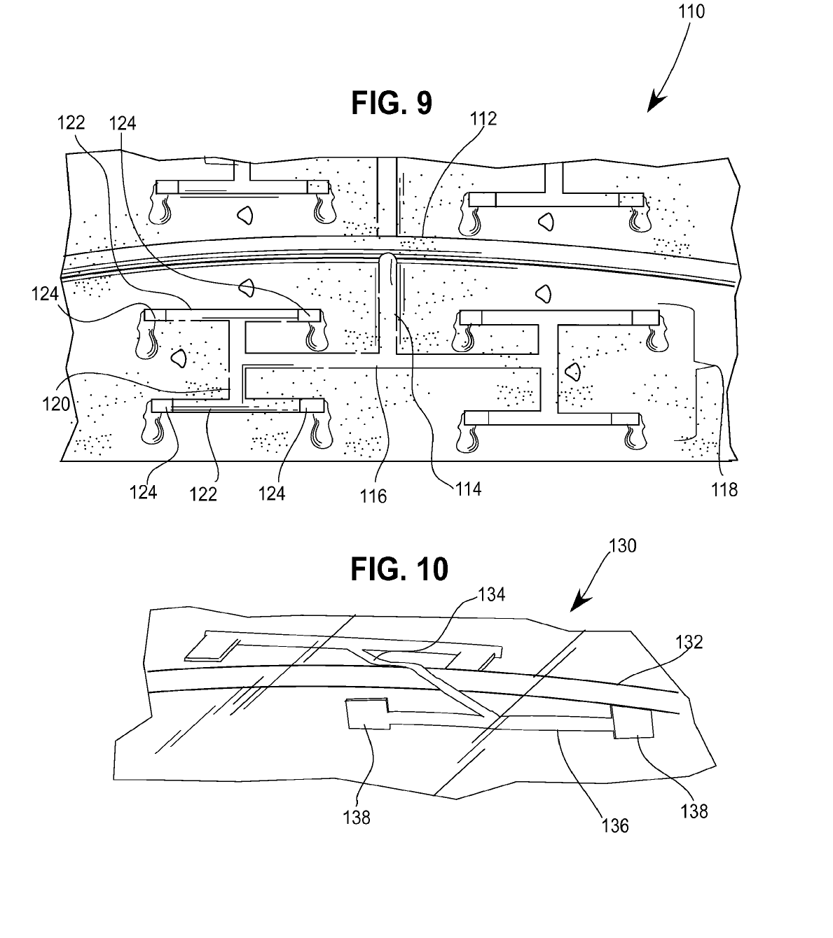

Drip irrigation tubing configured for improved distribution can also be provided in other forms, such as the alternative tubing arrangements of FIGS. 9-17.

The tubing arrangement 110 of the first alternative embodiment, shown in FIG. 9, includes a primary tube 112 configured to feed pathways formed between bonded plastic sheets. The pathways can include a moisture wicking material and terminate at openings 124 in the sheets. For example, the pathways can include a trunk 114 that feeds a main branch 116, each end of which feeds a secondary branch 120, which in turn feeds a pair of tertiary branches 122 each having an end terminating at the openings. In a second alternative embodiment, shown in FIG. 10, a tubing arrangement 130 includes a primary tube 132 feeding a trunk 134 that in turn feeds a branch 136, each end of which terminates at an opening 138. As in the first alternative embodiment, the pathways are disposed between sheets of plastic material and the openings 138 are formed therein, preferably on one side thereof, and the pathways can include a moisture wicking material, such as a geotextile material or other such permeable fabric.

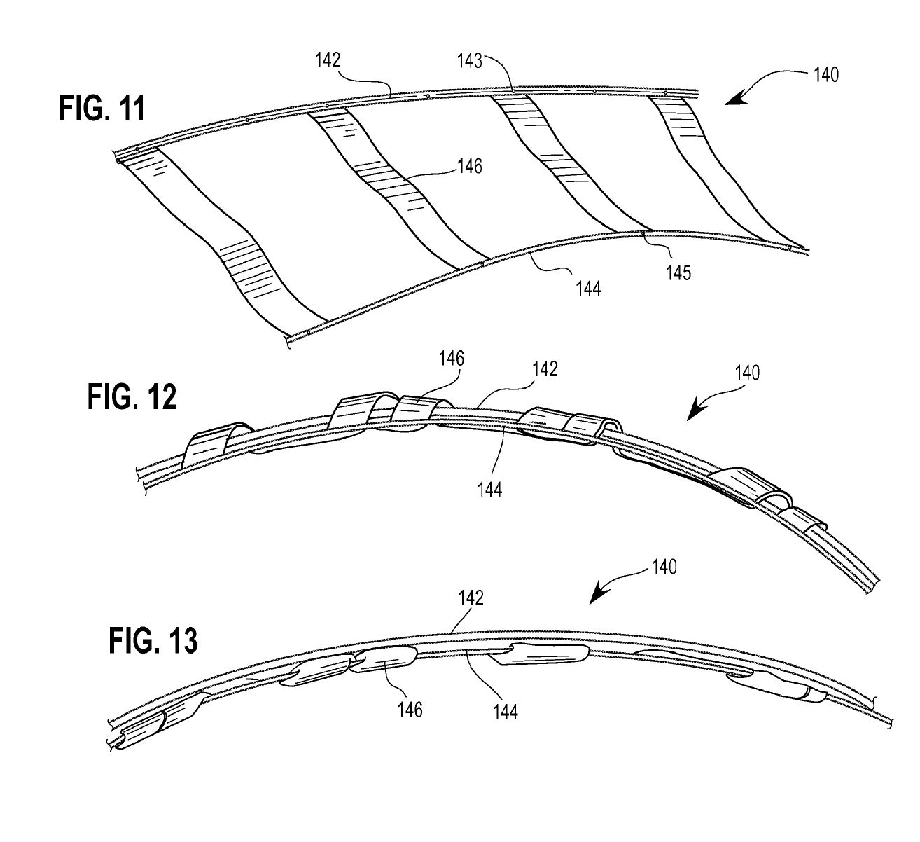

In a third alternative embodiment, illustrated in FIGS. 11-13, a preassembled tubing arrangement 140 includes a primary tube 142 and a secondary tube 144 connected by feed tubes 146. The primary tube 142 and the secondary tube 144 each include discrete emission points 143 and 145, respectively, at predetermined locations along the tubes 142 and 144. The feed tubes 146 serve to both facilitate consistent spacing of the secondary tube 144 from the primary tube 142, as well as feed water thereto. The feed tubes 146 can be provided preassembled and either be wound around the primary tube 142 (FIG. 12) or the secondary tube 144 (FIG. 13) in the tubing arrangements 140, and then can be coiled. Upon fluid pressurization of the primary tube 142, the fluid pressure can automatically cause deployment of the secondary tube 144.

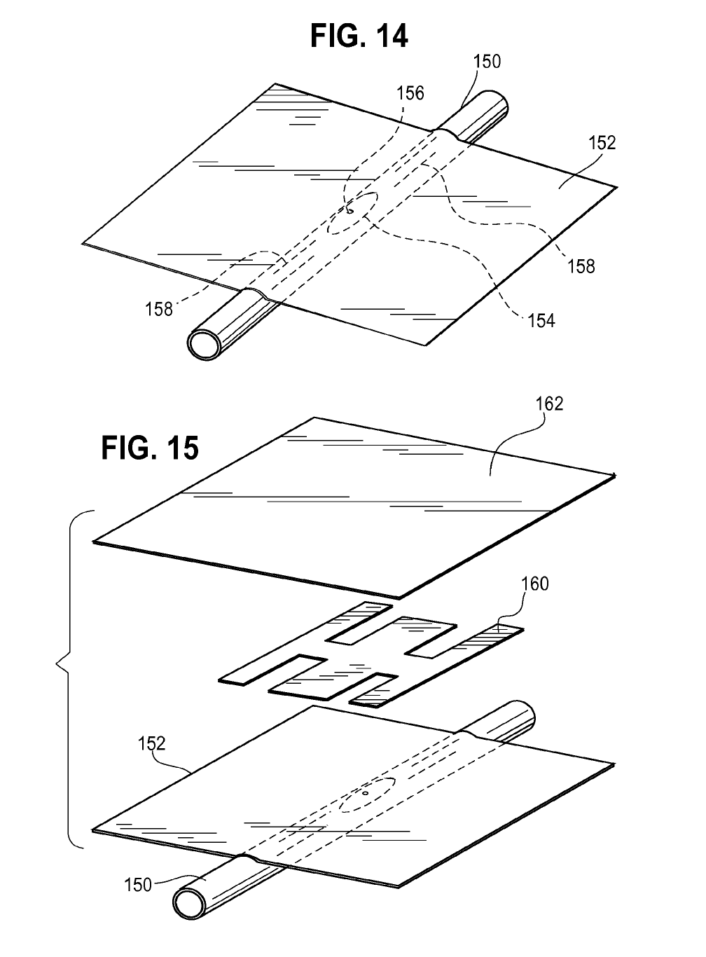

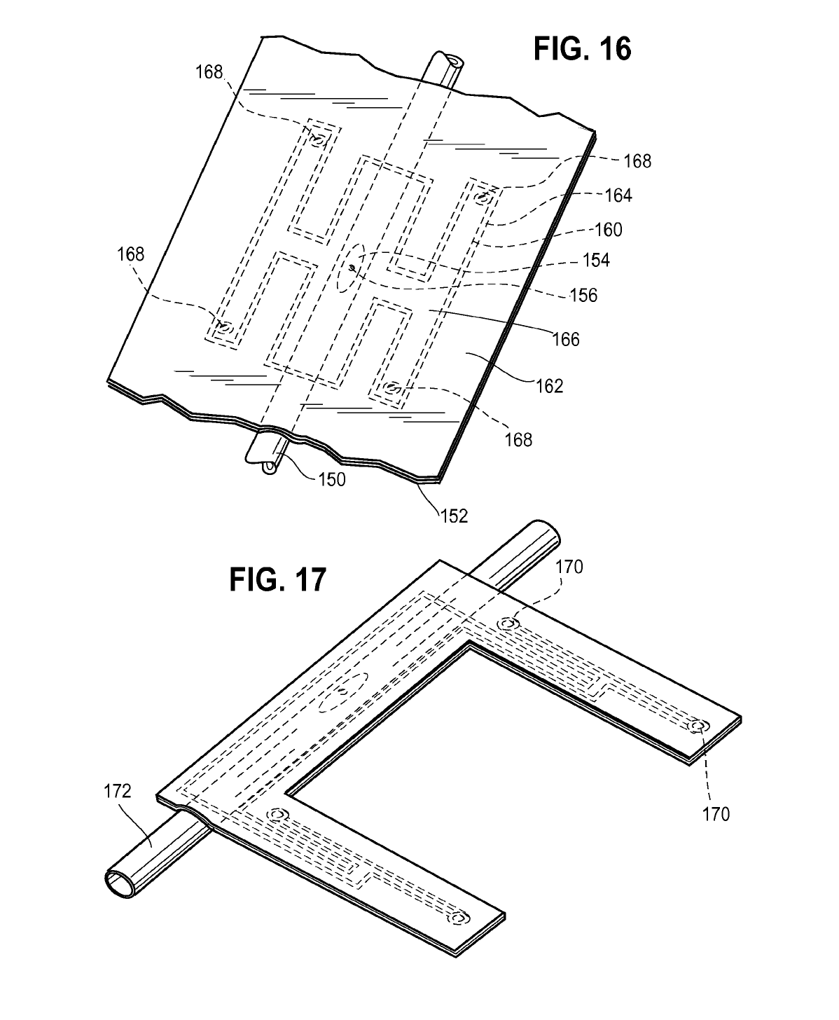

In the fourth alternative embodiment, shown in FIGS. 14-16, further details of the construction suitable for embodiments two and three are shown. A primary tube 150 has a lower sheet of film 152 attached thereto, such as by welding, adhesives or the like. More specifically, a closed loop 154 is welded around an opening 156 in the primary tube 150 and optional strengthening seals 158 are also formed, as shown in FIG. 15. A piece of permeable fabric 160 is then positioned between the attached lower sheet of film 152 and an upper sheet of film 162, as shown in FIG. 16. The permeable fabric 160 could include an adhesive layer to help the fabric stay in place to aid in manufacturing. Periphery seals 164 are then made between the two sheets of film 152 and 162 to define flow channels 166 leading to predetermined, discrete emission points 168 in the form of openings in one of the sheets of film (or optionally both), resulting in the tubing structure shown in FIG. 14 (which, as in the prior embodiments, is understood to be a fragment of the total length of tubing, as well as a fragment of the films). The primary tube preferably contains an in-line emitter that reduces pressure significantly upon exit from the primary tube. This then allows the films to be a thinner, more flexible material because they do not have to withstand high pressures. The flexible nature of the films permit them to be rolled or folded and wound into a coil, such that the emission points are closer to the primary tube 150 than when expanded. Yet another alternative is shown in the fifth alternative embodiment of FIG. 17, which is similar in construction to the previous embodiment, but shows the emission points 170 being all on the same side of the primary tube 172. Water pressure can be used to expand the tubing, as in any of the embodiments. Water is distributed through channels or flow paths between the two film layers by creating some back pressure. The back pressure is created to evenly distribute the water exiting from the primary tube, and generally enough pressure to make the effects of gravity negligible. The back pressure can be created with long small channels, channels with tortuous paths or drip teeth, which can be formed by the seal shapes between the two layers of film, and/or channels filled with or containing geotextile material to create a resistance needed.

To further explain alternative construction methods, the embodiments using the permeable fabric do so to provide a resistive path to create back pressure and ultimately the desired flow rate or range of rates. The permeable fabric 160 is generally shown as having an equal distance from the exit point of the primary tube in order to create the same emission rate from each discrete point. However, the desired flow rate can be achieved not only in this manner but instead or in addition having more or less cross-section of material to effectively change the required length to achieve a given flow rate, and eliminating the fabric altogether and using teeth (such as those shown in the emitter 42), preferably formed directly into the film as is done in drip tape products.

What is claimed is:

1. Preassembled drip tubing comprising at least one primary tube and a plurality of discrete, predefined emission points in fluid communication with the primary tube, the drip tubing movable from a coiled configuration to an expanded configuration, where the discrete emission points are farther from the primary tube as compared to in the coiled configuration, to form an array of the emission points.

2. The preassembled drip tubing of claim 1, comprising a pair of primary tubes connected by a plurality of secondary tubes, wherein the emission points are disposed on the secondary tubes.

3. The preassembled drip tubing of claim 2, wherein drip distributors are spaced along each of the primary tubes and comprise additional emission points.

4. The preassembled drip tubing of claim 1, further comprising copper to prevent root intrusion.

5. The preassembled drip tubing of claim 1, further comprising:
a pair of primary tubes;
drip distributors spaced along the primary tubes and rotatable relative thereto, the drip distributors of one of the primary tubes each having a corresponding drip distributor of the other of the primary tubes, each of the drip distributors configured for emitting fluid;
secondary tubes extending between corresponding pairs of drip distributors, the secondary tubes being configured for receiving emitted fluid from the drip distributors and emitting fluid from the discrete emission points; and
wherein, in the coiled configuration, the primary tubes are closer together than in the expanded configuration.

6. The preassembled drip tubing of claim 5, wherein the drip distributors are configured for pressure reduction.

7. The preassembled drip tubing of claim 6, wherein the drip distributors are configured for emitting fluid externally of the tubing.

8. The preassembled drip tubing of claim 7, wherein the secondary tubes have segments extending on opposite sides of both of the primary tubes.

9. The preassembled drip tubing of claim 8, wherein the segments of the secondary tubes are discrete and are not in fluid communication.

10. The preassembled drip tubing of claim 9, wherein the secondary tubes are each configured with at least four discrete emission points, one on each side of an adjacent one of the primary tubes.

11. The preassembled drip tubing of claim 5, wherein the primary and secondary tubes are in a generally ladder-shaped orientation in the expanded configuration.

12. The preassembled drip tubing of claim 5, wherein the drip distributors include an inlet in fluid communication with an associated one of the primary tubes and three outlets, one of the outlets configured for emitting fluid externally of the tubing, one of the outlets configured for emitting fluid to one segment of the secondary tubes, and another of the outlets configured for emitting fluid to another of the segments of the secondary tubes.

13. The preassembled drip tubing of claim 12, wherein the secondary tubes include a middle segment extending between corresponding ones of the drip distributors.

14. The preassembled drip tubing of claim 13, wherein the secondary tubes include lateral segments extending outward from corresponding ones of the drip distributors on opposite sides thereof from the middle segments.

15. The preassembled drip tubing of claim 1, further comprising:
secondary tubing and wherein the discrete emission points are disposed on the secondary tubing; and
a plurality of feed tubes, each of the feed tubes providing fluid communication from the primary tube to an associated one of the discrete emission points disposed on the secondary tubing.

16. The preassembled drip tubing of claim 15, wherein the feed tubes are wound around one of the primary tube and the secondary tube when the tubing is in the coiled configuration.

17. The preassembled drip tubing of claim 1, further comprising one or more sheets of film, and wherein the discrete emission points are defined by the one or more sheets of film.

18. The preassembled drip tubing of claim 17, further comprising fluid channels defined in the film for providing fluid communication between the primary tube and the discrete emission points.

19. The preassembled drip tubing of claim 18, wherein permeable fabric is provided in the fluid channels.

20. A method of installing the preassembled drip tubing of claim 1, the method comprising:
providing the tubing in the coiled configuration;
unwinding the tubing; and
moving the tubing to the expanded configuration.

21. Expandable drip emitter tubing comprising:
a pair of primary tubes;
drip distributors spaced along the primary tubes and rotatable relative thereto, the drip distributors of one of the primary tubes each having a corresponding drip distributor of the other of the primary tubes, each of the drip distributors configured for emitting fluid;
secondary tubes extending between corresponding pairs of drip distributors, the secondary tubes being configured for receiving emitted fluid from the drip distributors and emitting fluid; and
wherein the expandable drip emitter tubing arrangement is convertible from a first configuration, where the primary tubes are closer together, to a secondary configuration, where the primary tubes are spaced further apart, upon rotation of the corresponding drip distributors and secondary tubes relative the primary tubes.

22. The expandable drip emitter tubing of claim 21, wherein the drip distributors are configured for pressure reduction, the drip distributors are configured emitting fluid externally of the tubing, and the secondary tubes are configured for emitting fluid externally of the tubing.

23. The expandable drip emitter tubing of claim 22, wherein the secondary tubes have segments extending on opposite sides of both of the primary tubes, and wherein the segments of the secondary tubes are discrete and are not in fluid communication, and wherein the secondary tubes are each configured with at least four locations for emitting fluid, one on each side of an adjacent one of the primary tubes.
